(19) United States
(12) Patent Application Publication
(10) Pub. No.: US 2026/0244044 A1
(43) Pub. Date: Aug. 20, 2026

(54) DISPLAY PANEL, DISPLAY DEVICE, AND DRIVING METHOD

(71) Applicant: INFOVISION OPTOELECTRONICS (KUNSHAN) CO., LTD., Suzhou (CN)

(72) Inventors: Te-Chen CHUNG, Suzhou (CN); Limei JIANG, Suzhou (CN); Xianhe LIU, Suzhou (CN); Jiajun SHEN, Suzhou (CN)

(73) Assignee: INFOVISION OPTOELECTRONICS (KUNSHAN) CO., LTD., Suzhou, JS (CN)

(21) Appl. No.: 18/994,020

(22) PCT Filed: May 30, 2023
(86) PCT No.: PCT/CN2023/097275

§ 371 Date: Jan. 13, 2025

(51) Int. Cl. G02F 1/13; G02F 1/1362; G02F 1/1368; G09G 3/36

(52) U.S. Cl. CPC G02F 1/1323; G02F 1/136222; G02F 1/136286; G02F 1/1368; G09G 3/3648; G09G 2320/068

(57) ABSTRACT

A display panel, a display device, and a driving method are provided. The display panel includes a first liquid crystal cell and a second liquid crystal cell; the first liquid crystal cell includes a first substrate, a second substrate, and a dye liquid crystal layer; the first substrate is provided with a viewing angle auxiliary electrode; the second substrate is provided with a viewing angle control electrode; the second liquid crystal cell includes a color filter substrate, an array substrate, and a liquid crystal layer; a reflective polarizer is provided on the side of the second liquid crystal cell away from the first liquid crystal cell; and a prism structure layer having a light diffusion effect is provided in the first liquid crystal cell and/or the second liquid crystal cell.

### TECHNICAL FIELD

The present invention relates to the technical field of display technology, and in particular, to a display panel, a display device, and a driving method.

### DESCRIPTION OF RELATED ART

With the continuous progress of LCD technology, the viewing angle of the display device has been widened from about 112° to more than 160°. While people enjoy the visual experience brought by wide viewing angle, they also hope to effectively protect business secrets and personal privacy, so as to avoid the commercial loss or embarrassment caused by the leakage of screen information. Therefore, in addition to the requirement of wide viewing angle, the display device is also required to have the function of switching between wide and narrow viewing angle modes in many occasions.

At present, the main way to switch between wide and narrow viewing angle modes is to attach a louver shielding film onto the display screen. When it is necessary to prevent peeping, the louver shielding film can be used to cover the screen to reduce the viewing angle. However, this method requires additional preparation of the louver shielding film, which will cause great inconvenience to users, and a louver shielding film can only achieve one viewing angle. Once the louver shielding film is attached, the viewing angle will be fixed in the narrow viewing angle mode. As a result, it is impossible to switch freely between the wide viewing angle mode and the narrow viewing angle mode, and the louver shielding film will also reduce the brightness and the display effect.

### Technical Problem

The existing technology also uses a dual box structure composed of a light adjusting box and a display panel to switch between wide and narrow viewing angle modes. The display panel is used for normal image display, while the light adjusting box is used to control the switching of viewing angle modes. The light adjusting box includes an upper substrate, a lower substrate, and a liquid crystal layer between the upper and lower substrates. The viewing angle control electrodes on the upper and lower substrates apply a vertical electric field to the liquid crystal molecules, causing the liquid crystal molecules to deflect in a vertical direction and achieve a narrow viewing angle mode. By controlling the voltages on the viewing angle control electrodes, it is thus possible to realize the switching between wide and narrow viewing angle modes. This display panel utilizes a wide viewing angle to reduce brightness and achieve narrow viewing angle display. However, this display panel with switchable wide and narrow viewing angle modes has a ratio of about 1% between the display brightness at the left and right 45° and the display brightness at the center (0°) in the wide viewing angle mode, resulting in poor display performance at a large viewing angle. Moreover, in the existing technology, when improving the wide viewing angle display effect, the narrow viewing angle display effect will deteriorate; or when improving the narrow viewing angle display effect, the wide viewing angle display effect will deteriorate. It is thus difficult to realize that the narrow viewing angle display effect is not affected or can be improved while improving the wide viewing angle display effect.

### Technical Solution

In order to overcome the shortcomings and deficiencies in the prior art, the object of the present invention is to provide a display panel, a display device, and a driving method, to solve the problem that cannot be achieved in the existing technology that the narrow viewing angle display effect is not affected or can be improved while improving the wide viewing angle display effect.

The object of the present invention is realized by the following technical solutions:

The present invention provides a display panel including a first liquid crystal cell and a second liquid crystal cell stacked on top of each other, wherein the first liquid crystal cell is located on the light output side of the second liquid crystal cell;
the first liquid crystal cell includes a first substrate, a second substrate arranged opposite to the first substrate, and a dye liquid crystal layer located between the first substrate and the second substrate, the first substrate is provided with a viewing angle auxiliary electrode, and the second substrate is provided with a viewing angle control electrode that cooperates with the viewing angle auxiliary electrode;
the second liquid crystal cell includes a color film substrate, an array substrate arranged opposite to the color film substrate, and a liquid crystal layer arranged between the color film substrate and the array substrate;
a first polarizer is provided on the side of the second liquid crystal cell away from the first liquid crystal cell, and a second polarizer is provided on the side of the second liquid crystal cell near the first liquid crystal cell, the light transmission axis of the second polarizer is perpendicular to the light transmission axis of the first polarizer, the first polarizer is a reflective polarizer, a prism structure layer is provided in the first liquid crystal cell and/or the second liquid crystal cell, and the prism structure layer has a light diffusion effect on backlight.

Further, the second polarizer is a reflective polarizer; and/or a transflective layer is provided between the second polarizer and the first liquid crystal cell.

Further, the first liquid crystal cell has an identification pattern area and a non-identification pattern area, the viewing angle control electrode includes a first viewing angle control electrode corresponding to the identification pattern area and a second viewing angle control electrode corresponding to the non-identification pattern area, the first viewing angle control electrode and the second viewing angle control electrode are insulated and spaced apart from each other;
in the identification display mode, the first viewing angle control electrode and the second viewing angle control electrode are respectively applied with narrow viewing angle signals of different amplitudes.

Further, the first viewing angle control electrode and the second viewing angle control electrode are located on the same layer, or the first viewing angle control electrode and the second viewing angle control electrode are located on different layers.

Further, the array substrate is provided with multiple first scanning lines and multiple first data lines, the multiple first scanning lines and the multiple first data lines are insulated from each other and intersected to form multiple pixel units, the array substrate is provided with a pixel electrode and a first thin film transistor in each pixel unit, and the pixel electrode is electrically connected, through the first thin film transistor, to the first scanning line and the first data line adjacent to the first thin film transistor;
the second substrate is provided with multiple second scanning lines and multiple second data lines, the second scanning lines correspond to the first scanning lines, the second data lines correspond to the first data lines, the viewing angle control electrode includes multiple electrode blocks corresponding to the pixel units, the second substrate is provided with a second thin film transistor in each pixel unit, and the electrode block is electrically connected, through the second thin film transistor, to the second scanning line and the second data line adjacent to the second thin film transistor;
the first liquid crystal cell has an identification pattern area and a non-identification pattern area, and in the identification display mode, the electrode blocks corresponding to the identification pattern area and the electrode blocks corresponding to the non-identification pattern area are respectively applied with narrow viewing angle signals of different amplitudes.

Further, a third polarizer is provided on the side of the first liquid crystal cell away from the second liquid crystal cell, and the light transmission axis of the third polarizer is parallel to the light transmission axis of the second polarizer.

Further, a transflective layer is provided between the second polarizer and the first liquid crystal cell, the transflective layer is a unidirectional perspective film, the dye liquid crystal layer is aligned parallel to the first substrate and the second substrate, and the alignment direction of the dye liquid crystal layer is parallel to the light transmission axis of the third polarizer;
the array substrate is provided with multiple first scanning lines and multiple first data lines, the multiple first scanning lines and the multiple first data lines are insulated from each other and intersected to form multiple pixel units, the array substrate is provided with a pixel electrode and a first thin film transistor in each pixel unit, and the pixel electrode is electrically connected, through the first thin film transistor, to the first scanning line and the first data line adjacent to the first thin film transistor;
the second substrate is provided with multiple second scanning lines and multiple second data lines, the second scanning lines correspond to the first scanning lines, the second data lines correspond to the first data lines, the viewing angle control electrode includes multiple electrode blocks corresponding to the pixel units, the second substrate is provided with a second thin film transistor in each pixel unit, and the electrode block is electrically connected, through the second thin film transistor, to the second scanning line and the second data line adjacent to the second thin film transistor;
in the reflective display mode, corresponding grayscale voltages are applied to the electrode blocks.

Further, the first substrate and the second substrate are both colorless and transparent in the areas corresponding to the pixel units.

Further, the first substrate and/or the second substrate are provided with a protrusion on the side facing the dye liquid crystal layer, and the protrusion corresponds to the display area of the display panel.

Further, the prism structure layer is provided on the side of the second substrate facing the dye liquid crystal layer, and/or the prism structure layer is provided on the side of the array substrate facing the liquid crystal layer.

The present invention also provides a display device including a backlight module and the display panel as described above, wherein the display panel is provided on the light output side of the backlight module.

The present invention also provides a driving method used to drive the display panel as described above, the driving method including:
in the wide viewing angle mode, a common signal is applied to the viewing angle auxiliary electrode, and a wide viewing angle signal is applied to the viewing angle control electrode to control liquid crystal molecules and dye molecules in the dye liquid crystal layer to assume a standing posture;
in the narrow viewing angle mode, a common signal is applied to the viewing angle auxiliary electrode, and a narrow viewing angle signal is applied to the viewing angle control electrode to control the liquid crystal molecules and the dye molecules in the dye liquid crystal layer to assume a tilted posture.

Further, the second polarizer is a reflective polarizer, and/or a transflective layer is provided between the second polarizer and the first liquid crystal cell;
the first liquid crystal cell has an identification pattern area and a non-identification pattern area, the viewing angle control electrode includes a first viewing angle control electrode corresponding to the identification pattern area and a second viewing angle control electrode corresponding to the non-identification pattern area, the first viewing angle control electrode and the second viewing angle control electrode are insulated and spaced apart from each other;
in the identification display mode, a common signal is applied to the viewing angle auxiliary electrode, a first narrow viewing angle signal is applied to the first viewing angle control electrode, and a second narrow viewing angle signal is applied to the second viewing angle control electrode, the first narrow viewing angle signal and the second narrow viewing angle signal have different amplitudes, wherein the liquid crystal molecules and the dye molecules corresponding to the identification pattern area are controlled to assume a first tilted posture, and the liquid crystal molecules and the dye molecules corresponding to the non-identification pattern area are controlled to assume a second tilted posture.

Further, the second polarizer is a reflective polarizer, and/or a transflective layer is provided between the second polarizer and the first liquid crystal cell;
the first liquid crystal cell has an identification pattern area and a non-identification pattern area, and the viewing angle control electrode includes multiple electrode blocks corresponding to the pixel units;
in the identification display mode, a common signal is applied to the viewing angle auxiliary electrode, a first narrow viewing angle signal is applied to the electrode blocks corresponding to the identification pattern area, and a second narrow viewing angle signal is applied to the electrode blocks corresponding to the non-identification pattern area, the first narrow viewing angle signal and the second narrow viewing angle signal have different amplitudes, wherein the liquid crystal molecules and the dye molecules corresponding to the identification pattern area are controlled to assume a first tilted posture, and the liquid crystal molecules and the dye molecules corresponding to the non-identification pattern area are controlled to assume a second tilted posture.

Further, a transflective layer is provided between the second polarizer and the first liquid crystal cell, and the transflective layer is a unidirectional perspective film;
the first liquid crystal cell is provided with a third polarizer on the side away from the second liquid crystal cell, the light transmission axis of the third polarizer is parallel to the light transmission axis of the second polarizer, the dye liquid crystal layer is aligned parallel to the first substrate and the second substrate, and the alignment direction of the dye liquid crystal layer is parallel to the light transmission axis of the third polarizer, the viewing angle control electrode includes multiple electrode blocks corresponding to the pixel units;
in the reflective display mode, the backlight module and the second liquid crystal cell are turned off, a common signal is applied to the viewing angle auxiliary electrode, and corresponding grayscale voltages are applied to the electrode blocks.

### Beneficial Effects

By providing a prism structure layer with light diffusion effect, and combining it with a reflective polarizer provided on the side of the second liquid crystal cell away from the first liquid crystal cell, the display brightness in the wide viewing angle mode is ensured while improving the wide viewing angle display effect; further, the first liquid crystal cell uses dye molecules, and the dye molecules have a certain light receiving effect in the narrow viewing angle mode to reduce the influence of the prism structure layer on the narrow viewing angle display effect and enhance the narrow viewing angle display effect. By coordinating the prism structure layer, the reflective polarizer and the dye molecules, the wide viewing angle display effect is realized and improved while the narrow viewing angle display effect is not affected or can be improved.

### BRIEF DESCRIPTION OF THE DRAWINGS

FIG. 1 is a structural schematic diagram of the display device in the initial state according to the first embodiment of the present invention.

FIG. 2 is a schematic diagram of the planar structure of the array substrate according to the first embodiment of the present invention.

FIG. 3 is a waveform diagram of the driving signals of the display device according to the first embodiment of the present invention.

FIG. 4 is a structural schematic diagram of the display device in the wide viewing angle mode according to the first embodiment of the present invention.

FIG. 5 is a structural schematic diagram of the display device in the narrow viewing angle mode according to the first embodiment of the present invention.

FIG. 6 is a simulation diagram of the viewing angle and contrast of the first liquid crystal cell under different doping ratios of the dye molecules in the wide viewing angle mode according to the first embodiment of the present invention.

FIG. 7 is a simulation diagram of the viewing angle and contrast of the first liquid crystal cell under different doping ratios of the dye molecules in the narrow viewing angle mode according to the first embodiment of the present invention.

FIG. 8 is a measured graph of the viewing angle and transmittance of the first liquid crystal cell under different dye molecule doping ratios in the narrow viewing angle mode according to the first embodiment of the present invention.

FIG. 9 is a structural schematic diagram of the display device in the initial state according to the second embodiment of the present invention.

FIG. 10 is a structural schematic diagram of the display device in the initial state according to the third embodiment of the present invention.

FIG. 11 is a structural schematic diagram of the display device in the initial state according to the fourth embodiment of the present invention.

FIG. 12 is a structural schematic diagram of the display device in the initial state according to the fifth embodiment of the present invention.

FIG. 13 is a schematic diagram of the planar structure of the display device in the fifth embodiment of the present invention.

FIG. 14 is a schematic diagram of the planar structure of the viewing angle control electrode in the fifth embodiment of the present invention.

FIG. 15 is a waveform diagram of the driving signals of the display device in the fifth embodiment of the present invention.

FIG. 16 is a structural schematic diagram of the display device in the wide viewing angle mode according to the fifth embodiment of the present invention.

FIG. 17 is a structural schematic diagram of the display device in the narrow viewing angle mode according to the fifth embodiment of the present invention.

FIG. 18 is a structural schematic diagram of the display device in the identification display mode according to the fifth embodiment of the present invention.

FIG. 19 is a structural schematic diagram of the display device in the initial state according to the sixth embodiment of the present invention.

FIG. 20 is a schematic diagram of the planar structure of the second substrate in the sixth embodiment of the present invention.

FIG. 21 is a structural schematic diagram of the display device in the wide viewing angle mode according to the sixth embodiment of the present invention.

FIG. 22 is a structural schematic diagram of the display device in the narrow viewing angle mode according to the sixth embodiment of the present invention.

FIG. 23 is a structural schematic diagram of the display device in the identification display mode according to the sixth embodiment of the present invention.

FIG. 24 is a schematic diagram of the planar structure of the display device in the identification display mode according to the sixth embodiment of the present invention.

FIG. 25 is a structural schematic diagram of the display device in the reflective display mode according to the sixth embodiment of the present invention.

FIG. 26 is a first schematic diagram of the planar structure of the display device in the present invention.

FIG. 27 is a second schematic diagram of the planar structure of the display device in the present invention.

### DETAILED DESCRIPTION OF THE EMBODIMENTS

In order to further illustrate the technical solutions and effects of the present invention to achieve its intended purpose, the following describes the specific implementation mode, structures, features and effects of the display panel, the display device, and the driving method provided in the present invention in combination with the drawings and the preferred embodiments as follows.

### First Embodiment

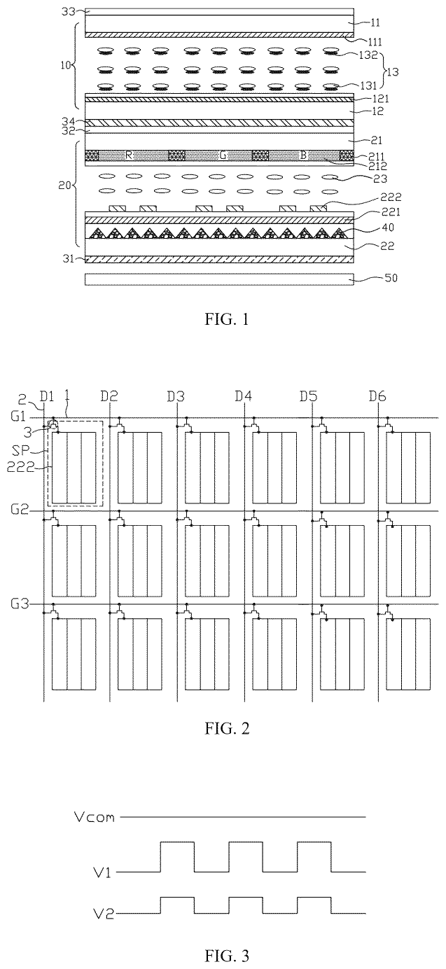

FIG. 1 is a structural schematic diagram of the display device in the initial state according to the first embodiment of the present invention. FIG. 2 is a schematic diagram of the planar structure of the array substrate according to the first embodiment of the present invention. As shown in FIGS. 1 and 2, the first embodiment of the present invention provides a display panel including a first liquid crystal cell 10 and a second liquid crystal cell 20 stacked on top of each other. The first liquid crystal cell 10 is located on the light output side of the second liquid crystal cell 20, that is, the first liquid crystal cell 10 is located on the side of the second liquid crystal cell 20 away from the backlight module 50.

The first liquid crystal cell 10 includes a first substrate 11, a second substrate 12 arranged opposite to the first substrate 11, and a dye liquid crystal layer 13 located between the first substrate 11 and the second substrate 12. The first substrate 11 is provided with a viewing angle auxiliary electrode 111, and the second substrate 12 is provided with a viewing angle control electrode 121 that cooperates with the viewing angle auxiliary electrode 111. By controlling the voltages applied to the viewing angle auxiliary electrode 111 and the viewing angle control electrode 121, the first liquid crystal cell 10 is controlled to switch between a wide viewing angle mode and a narrow viewing angle mode. In this embodiment, the viewing angle auxiliary electrode 111 and the viewing angle control electrode 121 are both planar electrodes arranged on the entire surface, so that all areas of the display device can be controlled to simultaneously switch between the wide viewing angle mode and the narrow viewing angle mode.

Further, an insulating layer covering the viewing angle auxiliary electrode 111 is provided on the first substrate 11, and/or an insulating layer covering the viewing angle control electrode 121 is provided on the second substrate 12 to avoid the problem of short circuit between the viewing angle auxiliary electrode 111 and the viewing angle control electrode 121.

The optical path difference Δn*d of the dye liquid crystal layer 13 is 700-1500 nm, for example 1393 nm. The dye liquid crystal layer 13 includes a mixture of liquid crystal molecules 131 and dye molecules 132. The liquid crystal molecules 131 are positive liquid crystal molecules (i.e., liquid crystal molecules with positive dielectric anisotropy), while the dye molecules 132 can be black dye molecules or purple black dye molecules. The light absorption ability of the long axis of the dye molecules is greater than that of the short axis, that is, the dye molecules 132 have a strong ability to absorb light on the long axis and a weak ability to absorb light on the short axis. As shown in FIG. 1, in the initial state, the positive liquid crystal molecules and the dye molecules 132 are aligned parallel to the first substrate 11 and the second substrate 12, and the alignment direction of the dye liquid crystal layer 13 on the side near the first substrate 11 is parallel or antiparallel to the alignment direction of the dye liquid crystal layer 13 on the side near the second substrate 12. It can be understood that the first substrate 11 is provided with a first alignment layer on the side facing the dye liquid crystal layer 13, and the second substrate 12 is provided with a second alignment layer on the side facing the dye liquid crystal layer 13. The first and second alignment layers are used to align the dye liquid crystal layer 13, and the alignment directions of the first and second alignment layers are parallel to each other. Of course, the dye liquid crystal layer 13 may have a small pre-tilt angle (e.g., less than 5°) during initial alignment, that is, in the initial state, the liquid crystal molecules 131 and the dye molecules 132 form a small angle with the first substrate 11 and the second substrate 12, which can accelerate the vertical deflection of the positive liquid crystal molecules and the dye molecules 132 when switching to the narrow viewing angle mode.

The second liquid crystal cell 20 includes a color film substrate 21, an array substrate 22 arranged opposite to the color film substrate 21, and a liquid crystal layer 23 arranged between the color film substrate 21 and the array substrate 22. In this embodiment, the liquid crystal molecules in the liquid crystal layer 23 also use positive liquid crystal molecules (i.e., liquid crystal molecules with positive dielectric anisotropy). As shown in FIG. 1, in the initial state, the positive liquid crystal molecules are aligned parallel to the color film substrate 21 and the array substrate 22, and the alignment direction of the liquid crystal layer 23 on the side near the color film substrate 21 is parallel or antiparallel to the alignment direction of the liquid crystal layer 23 on the side near the array substrate 22. Of course, the liquid crystal molecules in the liquid crystal layer 23 can also be negative liquid crystal molecules (i.e., liquid crystal molecules with negative dielectric anisotropy).

On the color film substrate 21, there are color resists 212 arranged in an array and a black matrix 211 that separates the color resists 212 from each other. The color resists 212 include color resist materials of red (R), green (G), and blue (B), and correspondingly form sub pixels of red (R), green (G), and blue (B), that is, the pixel units SP have three colors of red (R), green (G), and blue (B).

As shown in FIG. 2, the array substrate 22 is provided with multiple first scanning lines 1 and multiple first data lines 2. The multiple first scanning lines 1 and the multiple first data lines 2 are insulated from each other and intersected to form multiple pixel units SP. The array substrate 22 is provided with a pixel electrode 222 and a first thin film transistor 3 in each pixel unit SP. The pixel electrode 222 is electrically connected, through the first thin film transistor 3, to the first scanning line 1 and the first data line 2 adjacent to the first thin film transistor 3. Specifically, the first thin film transistor 3 includes a gate, an active layer, a drain, and a source, wherein the gate and the first scanning line 1 are located on the same layer and electrically connected, the gate and the active layer are separated by a gate insulation layer, the source is electrically connected to the first data line 2, and the drain is electrically connected to the pixel electrode 222.

As shown in FIG. 1, the array substrate 22 is provided with a common electrode 221 that cooperates with the pixel electrodes 222. The common electrode 221 and the pixel electrodes 222 are located on different layers and isolated by an insulating layer. The common electrode 221 can be located above or below the pixel electrodes 222 (as shown in FIG. 1, the common electrode 221 is located below the pixel electrodes 222). In this embodiment, the common electrode 221 is a planar structure, and the pixel electrode 222 in each pixel unit SP is a slit electrode with multiple electrode strips, thereby forming a fringe field switching (FFS) display mode. Of course, in other embodiments, the pixel electrodes 222 and the common electrode 221 may be located on the same layer, but they are insulated from each other, wherein each of the pixel electrode 222 and the common electrode 221 may include multiple electrode strips, and the electrode strips of the pixel electrode 222 and the electrode strips of the common electrode 221 are alternately arranged to form an in-plane switching (IPS) display mode. Alternatively, the array substrate 22 is provided with pixel electrodes 222 on the side facing the liquid crystal layer 23, and the color film substrate 21 is provided with a common electrode 221 on the side facing the liquid crystal layer 23 to form a TN display mode or a VA display mode. As for other introductions of TN display mode and VA display mode, please refer to the prior art and will not be repeated here.

Further, a prism structure layer 40 is provided in the first liquid crystal cell 10 and/or the second liquid crystal cell 20, and the prism structure layer 40 has a light diffusion effect on the backlight. In this embodiment, the prism structure layer 40 is provided on the array substrate 22 on the side facing the liquid crystal layer 23, and the backlight emitted by the backlight module 50 passes through the prism structure layer 40 in a diffusing state, thereby enhancing the wide viewing angle display effect. Specifically, the prism structure layer 40 includes a first refractive layer and a second refractive layer. The first refractive layer is provided with a convex structure, and the second refractive layer covers the first refractive layer. The longitudinal section of the convex structure can be triangular, trapezoidal, or semi-circular, and the convex structure has a cylindrical shape. The refractive index of the first refractive layer is smaller than the refractive index of the second refractive layer, so that the backlight after sequentially passing through the first and second refractive layers has a light diffusion effect.

As shown in FIG. 1, a first polarizer 31 is provided on the side of the second liquid crystal cell 20 away from the first liquid crystal cell 10, and a second polarizer 32 is provided on the side of the second liquid crystal cell 20 near the first liquid crystal cell 10. The light transmission axis of the second polarizer 32 is perpendicular to the light transmission axis of the first polarizer 31. Specifically, the first polarizer 31 is a reflective polarizer (APF, advanced polarizer film, full name: reflective polarizing ultra-thin optical film), with a mirror reflectivity (SCI) of over 46%. The reflective polarizer has a light transmission axis and a light reflection axis, and the light transmission axis and the light reflection axis of the reflective polarizer are perpendicular to each other. Due to the light diffusion effect of the prism structure layer 40 on the backlight, it will increase the viewing angle, but at the same time, the display brightness in the wide viewing angle mode is reduced. By providing a reflective polarizer on the side of the second liquid crystal cell 20 away from the first liquid crystal cell 10, the utilization of the backlight can be increased compared to an ordinary polarizer, thereby improving the display brightness in the wide viewing angle mode. By combining the prism structure layer 40 with the reflective polarizer, the wide viewing angle display effect is improved while ensuring good wide viewing angle display brightness.

Further, a transflective layer 34 is provided between the second polarizer 32 and the first liquid crystal cell 10. In this embodiment, the transflective layer 34 is a reflective polarizer (APF, advanced polarizer film, full name: reflective polarizing ultra-thin optical film), so that the transmission and reflection of light by the transflective layer 34 have an axial direction. As long as the polarization direction is parallel to the light transmission axis of the reflective polarizer, most of the light can pass through the reflective polarizer, thereby increasing the brightness of the transmitted backlight. Of course, in other embodiments, the transflective layer 34 can also be a unidirectional perspective film, wherein the unidirectional perspective film has no polarization effect on light, the backlight still remains natural light after passing through the unidirectional perspective film, and the ambient light still remains natural light after being reflected by the unidirectional perspective film. That is, regardless of the polarization direction of the light, the unidirectional perspective film has both transmission and reflection effects on it. Specifically, unidirectional perspective film (also called unidirectional film, mirror film, etc.) refers to a film that, when pasted on glass, can make the glass have a high reflectance to visible light. For example, when the outdoor environment is brighter than the indoor environment, unidirectional perspective film is similar to a regular mirror, the indoor scenery is unable to see from outdoors, but the outdoor scenery can be seen clearly from indoors. Unidirectional perspective film is commonly used as the film for home life glass or car glass. In the narrow viewing angle mode, due to the darker backlight passing through at a large viewing angle, the golden ambient light reflected by the transflective layer 34 can be seen, thereby enhancing the anti-peeping effect in the narrow viewing angle mode and achieving a golden anti-peeping effect.

In another embodiment, a viewing angle compensation film (not shown) or a composite film consisted of a viewing angle compensation film and a reflective polarizer can be provided between the second polarizer 32 and the first liquid crystal cell 10. The viewing angle compensation film has a certain light receiving effect, thereby further enhancing the anti-peeping effect in the narrow viewing angle mode. Specifically, the viewing angle compensation film can be combined with the transflective layer 34 to form one layer of film, that is, the viewing angle compensation film and the transflective layer 34 are bonded together in advance. Since the transflective layer 34 is relatively thin, by pre-bonding the viewing angle compensation film and the transflective layer 34 together, the thickness and strength can be increased, making it easier to bond the viewing angle compensation film and the transflective layer 34 between the second polarizer 32 and the first liquid crystal cell 10.

In this embodiment, a third polarizer 33 is provided on the side of the first liquid crystal cell 10 away from the second liquid crystal cell 20. The light transmission axis of the third polarizer 33 is parallel to the light transmission axis of the second polarizer 32, and the light transmission axis of the third polarizer 33 is perpendicular to the alignment direction of the dye liquid crystal layer 13. For example, if the light transmission axis of the third polarizer 33 and the light transmission axis of the second polarizer 32 are both 0°, then the alignment direction of the dye liquid crystal layer 13 is 90°, the light transmission axis of the first polarizer 31 (reflective polarizer) is 90°, and the light reflection axis of the first polarizer 31 is 0°.

Specifically, the first substrate 11, the second substrate 12, the color film substrate 21 and the array substrate 22 can be made of materials such as glass, acrylic, and polycarbonate. The materials of the viewing angle auxiliary electrode 111, the viewing angle control electrode 121, the common electrode 221 and the pixel electrode 222 can be transparent materials such as indium tin oxide (ITO) or indium zinc oxide (IZO).

The present invention also provides a display device including a backlight module 50 and the display panel as described above, wherein the display panel is provided on the light output side of the backlight module 50, and the backlight module 50 is used to provide a backlight source for the display panel. Specifically, the backlight module 50 can adopt a collimated backlight module, a side entry backlight module, or a concentrated backlight module.

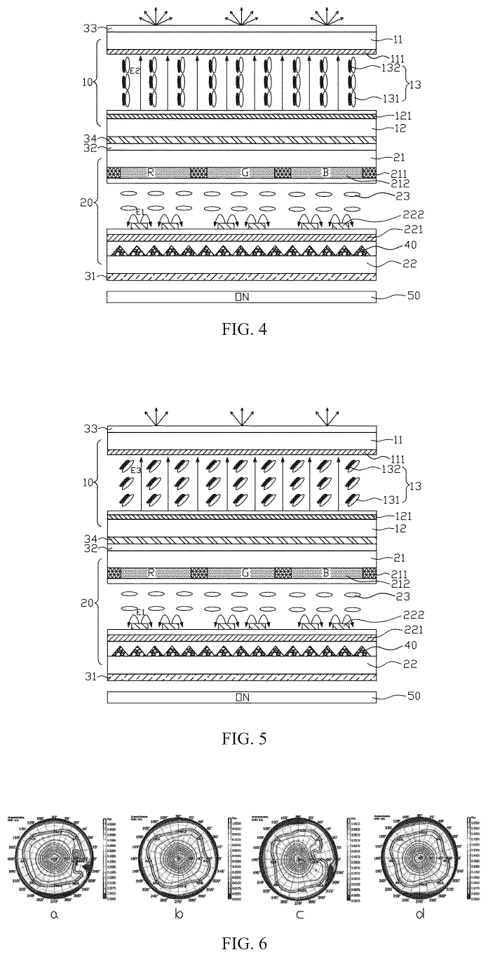

FIG. 3 is a waveform diagram of the driving signals of the display device according to the first embodiment of the present invention. FIG. 4 is a structural schematic diagram of the display device in the wide viewing angle mode according to the first embodiment of the present invention. FIG. 5 is a structural schematic diagram of the display device in the narrow viewing angle mode according to the first embodiment of the present invention. As shown in FIGS. 3 to 5, the present invention also provides a driving method for driving the display panel as described above. The driving method includes:

As shown in FIGS. 3 and 4, in the wide viewing angle mode, the backlight module 50 is in the on state. A common signal Vcom is applied to the viewing angle auxiliary electrode 111, and a wide viewing angle signal V1 is applied to the viewing angle control electrode 121, so that there is a large voltage difference (e.g., 5-10V) between the viewing angle auxiliary electrode 111 and the viewing angle control electrode 121, thereby forming a strong vertical electric field (E2 in FIG. 4) between the viewing angle auxiliary electrode 111 and the viewing angle control electrode 121, which controls the liquid crystal molecules 131 and the dye molecules 132 in the dye liquid crystal layer 13 to deflect in a vertical direction and assume a standing posture to thereby achieve a wide viewing angle display effect.

In the wide viewing angle mode, a common voltage is applied to the common electrode 221, and a corresponding grayscale voltage is applied to the pixel electrode 222. A voltage difference is formed between the pixel electrode 222 and the common electrode 221, thereby generating a horizontal electric field (E1 in FIG. 4). The positive liquid crystal molecules in the liquid crystal layer 23 are deflected in the horizontal direction, thereby controlling the intensity of light passing through the liquid crystal layer 23 and achieving grayscale display. The grayscale voltage includes 0-255 levels of grayscale voltage. When different grayscale voltages are applied to the pixel electrodes 222, the pixel units SP exhibit different brightness, thereby displaying different images in the wide viewing angle mode, to thereby achieve normal display of the display device in the wide viewing angle mode.

In the wide viewing angle mode, by setting a prism structure layer 40 with light diffusion effect and combining it with a first polarizer 31 on the side of the second liquid crystal cell 20 away from the first liquid crystal cell 10, the prism structure layer 40 and the first polarizer 31 cooperate with each other to enhance the wide viewing angle display effect while ensuring that the display device has good wide viewing angle display brightness. In the wide viewing angle mode, due to the standing posture of the liquid crystal molecules 131 and the dye molecules 132 in the dye liquid crystal layer 13, the dye molecules 132 basically do not absorb light. Therefore, the dye molecules 132 will not affect the display effect in the wide viewing angle mode. Moreover, in the wide viewing angle mode, regardless of whether it is from a large viewing angle or a frontal angle (0°), the backlight passing through is relatively strong and can cover the golden ambient light reflected by the transflective layer 34. Therefore, the golden ambient light reflected by the transflective layer 34 has little impact on the display in the wide viewing angle mode.

As shown in FIGS. 3 and 5, in the narrow viewing angle mode, the backlight module 50 is in the on state. A common signal Vcom is applied to the viewing angle auxiliary electrode 111, and a narrow viewing angle signal V2 is applied to the viewing angle control electrode 121, so that there is a relatively large voltage difference between the viewing angle auxiliary electrode 111 and the viewing angle control electrode 121 (e.g., 1.5-3V, preferably 2.7V), thereby forming a relatively strong vertical electric field (E3 in FIG. 5) between the viewing angle auxiliary electrode 111 and the viewing angle control electrode 121, which controls the liquid crystal molecules 131 and the dye molecules 132 in the dye liquid crystal layer 13 to deflect in a vertical direction and assume a tilted posture. The dye liquid crystal layer 13 has a light receiving effect at a large viewing angle, that is, the brightness becomes dark at a large viewing angle, to thereby achieve a narrow viewing angle display effect.

In the narrow viewing angle mode, a common voltage is applied to the common electrode 221, and a corresponding grayscale voltage is applied to the pixel electrode 222. A voltage difference is formed between the pixel electrode 222 and the common electrode 221, thereby generating a horizontal electric field (E1 in FIG. 5). The positive liquid crystal molecules in the liquid crystal layer 23 are deflected in the horizontal direction, thereby controlling the intensity of light passing through the liquid crystal layer 23 and achieving grayscale display. The grayscale voltage includes 0-255 levels of grayscale voltage. When different grayscale voltages are applied to the pixel electrodes 222, the pixel units SP exhibit different brightness, thereby displaying different images in the narrow viewing angle mode, to thereby achieve normal display of the display device in the narrow viewing angle mode.

In the narrow viewing angle mode, due to the use of the dye liquid crystal layer 13, the dye molecules 132 in the dye liquid crystal layer 13 have strong ability to absorb light on the long axis and weak ability to absorb light on the short axis. In the narrow viewing angle mode, the dye molecules 132 can absorb some light, thereby increasing the light receiving effect in the narrow viewing angle mode and accordingly improving the narrow viewing angle display effect. Moreover, a transflective layer 34 is provided between the second polarizer 32 and the first liquid crystal cell 10. Since the backlight transmitted at a large viewing angle is relatively dark in the narrow viewing angle mode, the golden ambient light reflected by the transflective layer 34 can be seen, further enhancing the anti-peeping effect in the narrow viewing angle mode and achieving a golden anti-peeping effect. In the narrow viewing angle mode, the backlight passing through the frontal angle (0°) is relatively strong and can cover the golden ambient light reflected by the transflective layer 34. Therefore, the golden ambient light reflected by the transflective layer 34 at the frontal angle is basically invisible, that is, in the narrow viewing angle mode, the golden ambient light reflected by the transflective layer 34 has little impact on the display at the frontal angle.

The wide viewing angle signal V1 applied to the viewing angle control electrode 121 in the wide viewing angle mode is greater than the narrow viewing angle signal V2 applied to the viewing angle control electrode 121 in the narrow viewing angle mode, so that the voltage difference between the viewing angle auxiliary electrode 111 and the viewing angle control electrode 121 in the wide viewing angle mode is greater than the voltage difference between the viewing angle auxiliary electrode 111 and the viewing angle control electrode 121 in the narrow viewing angle mode.

Table 1 shows the comparison data between the display device of the present invention and the display device in the prior art in terms of the narrow viewing angle display effect and the wide viewing angle display effect:

TABLE 1

| | Prior art | | Present application | |
|---|---|---|---|---|
| Display mode | WVA | NVA | WVA | NVA |
| Central brightness | 985(100%) | 325(100%) | 1050(106.6%) | 343(105.5%) |
| R-45deg. | 1.12% | 0.30% | 4.54% | 0.34% |
| L-45deg. | 1.05% | 0.25% | 4.32% | 0.31% |
| R-45deg. (brightness) | 11.0 | 0.98 | 47.7 | 1.16 |
| L-45deg. (brightness) | 10.3 | 0.81 | 45.4 | 1.06 |

From Table 1 above, it can be seen that in the wide viewing angle (WVA) mode, the ratio of the brightness at the left and right 45° to the brightness at the center (0°) in the present invention has increased from 1.05% and 1.12% to 4.32% and 4.54%, respectively, compared to the prior art. In the narrow viewing angle (NVA) mode, the narrow viewing angle display effect of the present invention is comparable to that of the prior art. Of course, the display effect in the narrow viewing angle mode can also be improved by increasing the doping ratio of the dye molecules 132.

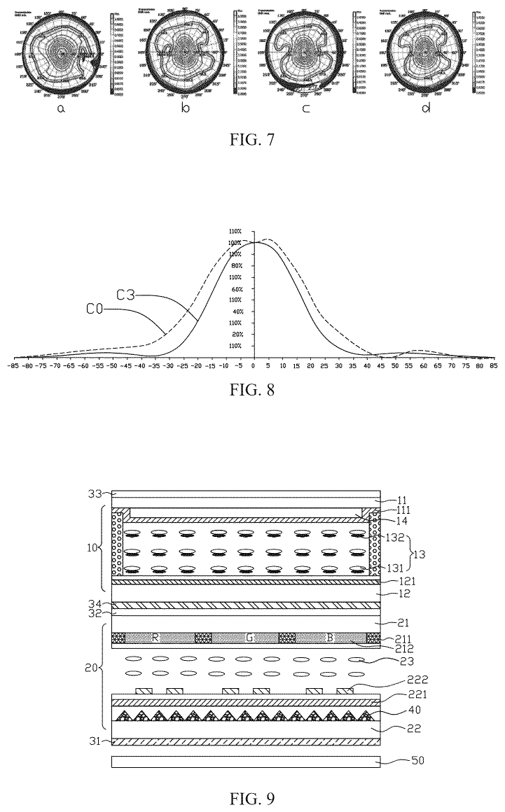

FIG. 6 is a simulation diagram of the viewing angle and contrast of the first liquid crystal cell under different doping ratios of the dye molecules in the wide viewing angle mode according to the first embodiment of the present invention. FIG. 7 is a simulation diagram of the viewing angle and contrast of the first liquid crystal cell under different doping ratios of the dye molecules in the narrow viewing angle mode according to the first embodiment of the present invention. FIG. 8 is a measured graph of the viewing angle and transmittance of the first liquid crystal cell under different dye molecule doping ratios in the narrow viewing angle mode according to the first embodiment of the present invention. As shown in FIGS. 6 and 7, “a” represents the measured graph when the doping ratio of the dye molecules 132 in the dye liquid crystal layer 13 is 0, “b” represents the measured graph when the doping ratio of the dye molecules 132 in the dye liquid crystal layer 13 is 1%. “c” represents the measured graph when the doping ratio of the dye molecules 132 in the dye liquid crystal layer 13 is 2%, and “d” represents the measured graph when the doping ratio of the dye molecules 132 in the dye liquid crystal layer 13 is 3%. As shown in FIG. 8, curve “C0” represents the simulation curve when the doping ratio of the dye molecules 132 in the dye liquid crystal layer 13 is 0, and curve “C3” represents the simulation curve when the doping ratio of the dye molecules 132 in the dye liquid crystal layer 13 is 3%. From FIG. 6, it can be seen that the doping ratio of the dye molecules 132 has little impact on the wide viewing angle display effect of the first liquid crystal cell 10; from FIGS. 7 and 8, it can be seen that the doping ratio of the dye molecules 132 has a significant impact on the narrow viewing angle display effect of the first liquid crystal cell 10.

Table 2 shows the experimental data of the first liquid crystal cell 10 under doping ratios of the dye molecules 132 ranging from 0-3%. Please refer to Table 2 below:

TABLE 2

| Viewing | 0% doping | 1% doping | 2% doping | 3% doping |
|---|---|---|---|---|
| angle | ratio | ratio | ratio | ratio |
| −45°/45° | 9.4% | 4.6% | 3.5% | 2.8% |
| 0° | 100% | 100% | 100% | 100% |

From Table 2 above, it can be seen that the doping ratio of the dye molecules 132 has a significant impact on the narrow viewing angle display effect of the first liquid crystal cell 10. Therefore, by controlling the doping ratio of the dye molecules 132 in the first liquid crystal cell 10, the light receiving effect of the first liquid crystal cell 10 in the narrow viewing angle mode can be controlled. Specifically, FIGS. 6-8 and Table 2 are only test data for the first liquid crystal cell 10 individually.

### Second Embodiment

FIG. 9 is a structural schematic diagram of the display device in the initial state according to the second embodiment of the present invention. As shown in FIG. 9, the display panel, display device, and driving method provided in the second embodiment of the present invention are basically the same as those in the first embodiment (FIGS. 1 to 5), except that in this embodiment:

The first substrate 11 is provided with a protrusion 14 on the side facing the dye liquid crystal layer 13, and the protrusion 14 corresponds to the display area of the display panel, that is, the projection of the protrusion 14 on the first substrate 11 coincides with the display area. Specifically, the protrusion 14 can be made of an overcoat layer (OC), which involves first forming an entire overcoat layer and then removing the overcoat layer corresponding to the non-display area to retain the overcoat layer corresponding to the display area and form the protrusion 14. Due to the tendency of the first substrate 11 to bend after thinning treatment, it is easy for the first substrate 11 and the second substrate 12 to adsorb together and form abnormal rainbow patterns. By setting the protrusion 14 in the display area, the strength of the first substrate 11 after thinning treatment can be enhanced, the distance between the first substrate 11 and the second substrate 12 at the edges can be increased, and the first substrate 11 and the second substrate 12 can be avoided from being easily adsorbing together. Moreover, only setting the protrusion 14 in the display area will not affect the thickness of the first liquid crystal cell 10, and can also avoid the problem of peripheral color difference caused by simply increasing the size of silicon balls (SP size). Of course, in other embodiments, the protrusion 14 can also be provided on the second substrate 12 on the side facing the dye liquid crystal layer 13, or both the first substrate 11 and the second substrate 12 can have protrusions 14 provided on the side facing the dye liquid crystal layer 13.

A person skilled in the art should understand that the remaining structures and working principles of this embodiment are the same as those of the first embodiment, and will not be repeated here.

### Third Embodiment

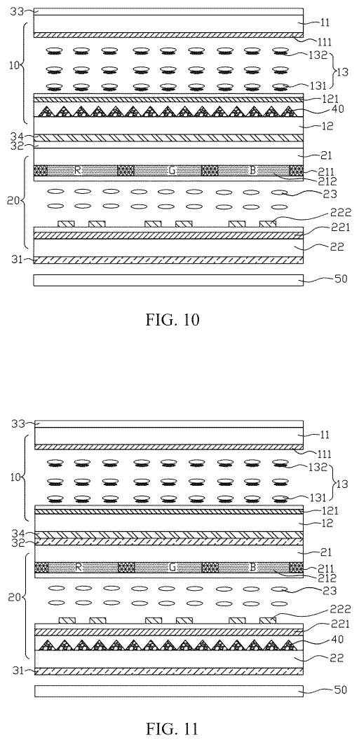

FIG. 10 is a structural schematic diagram of the display device in the initial state according to the third embodiment of the present invention. As shown in FIG. 10, the display panel, display device, and driving method provided in the third embodiment of the present invention are basically the same as those in the first embodiment (FIGS. 1 to 5) and the second embodiment (FIG. 9), except that in this embodiment:

A prism structure layer 40 is provided on the side of the second substrate 12 facing the dye liquid crystal layer 13, and has a light diffusion effect on the backlight. The backlight emitted by the backlight module 50 passes through the prism structure layer 40 in a diffusing state, thereby enhancing the wide viewing angle display effect. Specifically, the prism structure layer 40 includes a first refractive layer and a second refractive layer. The first refractive layer is provided with a convex structure, and the second refractive layer covers the first refractive layer. The longitudinal section of the convex structure can be triangular, trapezoidal, or semi-circular, and the convex structure has a cylindrical shape. The refractive index of the first refractive layer is smaller than the refractive index of the second refractive layer, so that the backlight after sequentially passing through the first and second refractive layers has a light diffusion effect. Of course, the prism structure layer 40 can be provided simultaneously on the array substrate 22 on the side facing the liquid crystal layer 23 and on the second substrate 12 on the side facing the dye liquid crystal layer 13, thereby further enhancing the wide viewing angle display effect.

A person skilled in the art should understand that the remaining structures and working principles of this embodiment are the same as those of the first and second embodiments, and will not be repeated here.

### Fourth Embodiment

FIG. 11 is a structural schematic diagram of the display device in the initial state according to the fourth embodiment of the present invention. As shown in FIG. 11, the display panel, display device, and driving method provided in the fourth embodiment of the present invention are basically the same as those in the first embodiment (FIGS. 1 to 5), the second embodiment (FIG. 9) and the third embodiment (FIG. 10), except that in this embodiment:

The second polarizer 32 is a reflective polarizer, that is, the second polarizer 32 has a light transmission axis and a light reflection axis, and the light transmission axis and the light reflection axis of the second polarizer 32 are perpendicular to each other. For example, the second polarizer 32 is a reflective polarizer (APF, advanced polarizer film, reflective polarizing ultra-thin optical film), with a mirror reflectivity (SCI) of over 46%. By also using a reflective polarizer for the second polarizer 32 and combining it with a transflective layer 34, the reflection effect on ambient light can be increased to enhance the anti-peeping effect in the narrow viewing angle mode and achieve a golden anti-peeping effect. Of course, in other embodiments, when the second polarizer 32 also uses a reflective polarizer, due to the reflective effect of the reflective polarizer, there is no need to set the transflective layer 34. In this case, a viewing angle compensation film can be individually provided between the second polarizer 32 and the first liquid crystal cell 10, but the reflection effect on ambient light may be slightly worse.

A person skilled in the art should understand that the remaining structures and working principles of this embodiment are the same as those of the first, second and third embodiments, and will not be repeated here.

### Fifth Embodiment

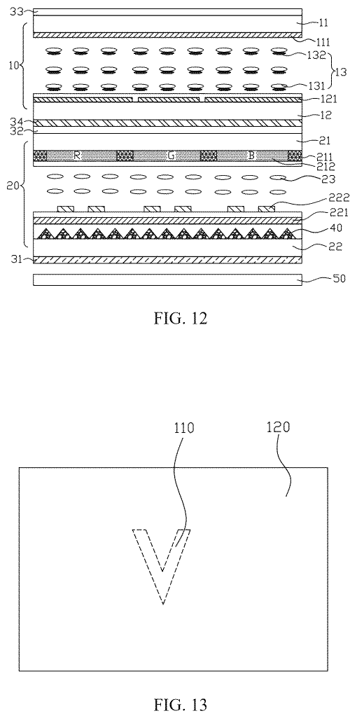

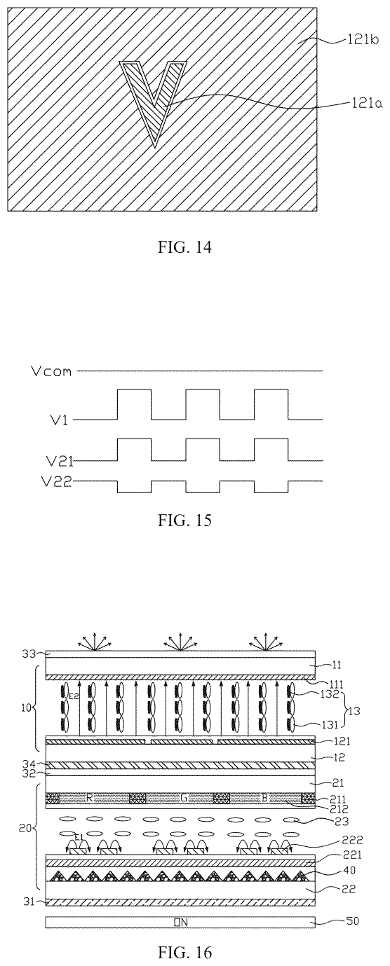

FIG. 12 is a structural schematic diagram of the display device in the initial state according to the fifth embodiment of the present invention. FIG. 13 is a schematic diagram of the planar structure of the display device in the fifth embodiment of the present invention. FIG. 14 is a schematic diagram of the planar structure of the viewing angle control electrode in the fifth embodiment of the present invention. As shown in FIGS. 12 to 14, the display panel, display device, and driving method provided in the fifth embodiment of the present invention are basically the same as those in the first embodiment (FIGS. 1 to 5), the second embodiment (FIG. 9), the third embodiment (FIG. 10) and the fourth embodiment (FIG. 11), except that in this embodiment:

The first liquid crystal cell 10 has an identification pattern area 110 and a non-identification pattern area 120. The viewing angle control electrode 121 includes a first viewing angle control electrode 121a corresponding to the identification pattern area 110 and a second viewing angle control electrode 121b corresponding to the non-identification pattern area 120. The first viewing angle control electrode 121a and the second viewing angle control electrode 121b are insulated and spaced apart from each other, so that narrow viewing angle signals of different amplitudes can be applied to the first viewing angle control electrode 121a and the second viewing angle control electrode 121b in an identification display mode. Specifically, the pattern of the identification pattern area 110 can be set according to actual needs. The pattern of the first viewing angle control electrode 121a is the same as that of the identification pattern area 110. However, when the first liquid crystal cell 10 is completed, the pattern of the identification pattern area 110 cannot be changed. In the identification display mode, only the same identification pattern can be displayed.

In this embodiment, the first viewing angle control electrode 121a and the second viewing angle control electrode 121b are located on the same layer, wherein the non-identification pattern area 120 surrounds the periphery of the identification pattern area 110, and the second viewing angle control electrode 121b surrounds the periphery of the first viewing angle control electrode 121a. Therefore, an additional signal wire layer can be provided to electrically connect the first viewing angle control electrode 121a to a binding area of the non-display area, thereby facilitating to apply control signals to the first viewing angle control electrode 121a. Of course, in other embodiments, the first viewing angle control electrode 121a and the second viewing angle control electrode 121b are located on different layers, and there is no need to additionally set up a signal wire layer. However, since the first viewing angle control electrode 121a and the second viewing angle control electrode 121b are located on different layers and have different distances from the viewing angle auxiliary electrode 111, there is a certain impact on the narrow viewing angle display effect of the display device.

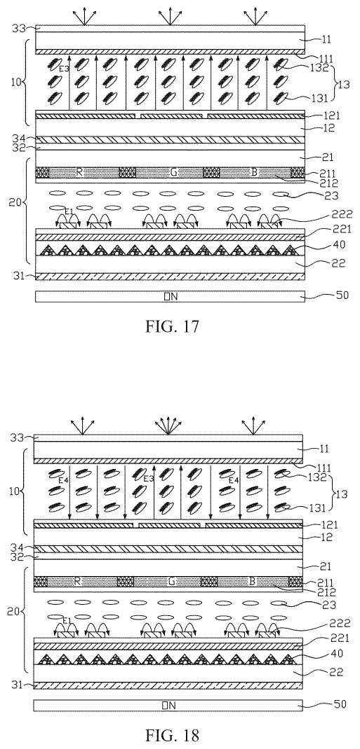

FIG. 15 is a waveform diagram of the driving signals of the display device in the fifth embodiment of the present invention. FIG. 16 is a structural schematic diagram of the display device in the wide viewing angle mode according to the fifth embodiment of the present invention. FIG. 17 is a structural schematic diagram of the display device in the narrow viewing angle mode according to the fifth embodiment of the present invention. FIG. 18 is a structural schematic diagram of the display device in the identification display mode according to the fifth embodiment of the present invention. As shown in FIGS. 15 to 18, the present invention also provides a driving method for driving the display panel as described above. The driving method includes:

As shown in FIGS. 15 and 16, in the wide viewing angle mode, the backlight module 50 is in the on state, and a common signal Vcom is applied to the viewing angle auxiliary electrode 111, and a wide viewing angle signal V1 is applied to the viewing angle control electrode 121, that is, the wide viewing angle signal V1 is applied to both the first viewing angle control electrode 121a and the second viewing angle control electrode 121b, so that there is a large voltage difference (e.g., 5-10V) between the viewing angle auxiliary electrode 111 and the first viewing angle control electrode 121a, and between the viewing angle auxiliary electrode 111 and the second viewing angle control electrode 121b, thereby forming a strong vertical electric field (E2 in FIG. 16) between the viewing angle auxiliary electrode 111 and the first viewing angle control electrode 121a, and between the viewing angle auxiliary electrode 111 and the second viewing angle control electrode 121b, which controls all the liquid crystal molecules 131 and the dye molecules 132 in the dye liquid crystal layer 13 to deflect in a vertical direction and assume a standing posture to thereby achieve a wide viewing angle display effect.

In the wide viewing angle mode, a common voltage is applied to the common electrode 221, and a corresponding grayscale voltage is applied to the pixel electrode 222. A voltage difference is formed between the pixel electrode 222 and the common electrode 221, thereby generating a horizontal electric field (E1 in FIG. 16). The positive liquid crystal molecules in the liquid crystal layer 23 are deflected in the horizontal direction, thereby controlling the intensity of light passing through the liquid crystal layer 23 and achieving grayscale display. The grayscale voltage includes 0-255 levels of grayscale voltage. When different grayscale voltages are applied to the pixel electrodes 222, the pixel units SP exhibit different brightness, thereby displaying different images in the wide viewing angle mode, to thereby achieve normal display of the display device in the wide viewing angle mode.

In the wide viewing angle mode, by setting a prism structure layer 40 with light diffusion effect and combining it with a first polarizer 31 on the side of the second liquid crystal cell 20 away from the first liquid crystal cell 10, the prism structure layer 40 and the first polarizer 31 cooperate with each other to enhance the wide viewing angle display effect while ensuring good wide viewing angle display brightness. In the wide viewing angle mode, due to the standing posture of the liquid crystal molecules 131 and the dye molecules 132 in the dye liquid crystal layer 13, the dye molecules 132 basically do not absorb light. Therefore, the dye molecules 132 will not affect the display effect in the wide viewing angle mode. Moreover, in the wide viewing angle mode, regardless of whether it is from a large viewing angle or a frontal angle (0°), the backlight passing through is relatively strong and can cover the golden ambient light reflected by the transflective layer 34. Therefore, the golden ambient light reflected by the transflective layer 34 has little impact on the display in the wide viewing angle mode.

As shown in FIGS. 15 and 17, in the narrow viewing angle mode, the backlight module 50 is in the on state. A common signal Vcom is applied to the viewing angle auxiliary electrode 111, and a narrow viewing angle signal V2 is applied to the viewing angle control electrode 121, that is, a first narrow viewing angle signal V21 or a second narrow viewing angle signal V22 is applied to both the first viewing angle control electrode 121a and the second viewing angle control electrode 121b, so that there is a relatively large voltage difference (e.g., 1.5-3V, preferably 2.7V) between the viewing angle auxiliary electrode 111 and the first viewing angle control electrode 121a, and between the viewing angle auxiliary electrode 111 and the second viewing angle control electrode 121b, thereby forming a relatively strong vertical electric field (E3 in FIG. 17) between the viewing angle auxiliary electrode 111 and the first viewing angle control electrode 121a, and between the viewing angle auxiliary electrode 111 and the second viewing angle control electrode 121b, which controls all the liquid crystal molecules 131 and the dye molecules 132 in the dye liquid crystal layer 13 to deflect in a vertical direction and assume the same tilted posture. The dye liquid crystal layer 13 has a light receiving effect at a large viewing angle, that is, the brightness becomes dark at a large viewing angle, to thereby achieve a narrow viewing angle display effect.

In the narrow viewing angle mode, a common voltage is applied to the common electrode 221, and a corresponding grayscale voltage is applied to the pixel electrode 222. A voltage difference is formed between the pixel electrode 222 and the common electrode 221, thereby generating a horizontal electric field (E1 in FIG. 17). The positive liquid crystal molecules in the liquid crystal layer 23 are deflected in the horizontal direction, thereby controlling the intensity of light passing through the liquid crystal layer 23 and achieving grayscale display. The grayscale voltage includes 0-255 levels of grayscale voltage. When different grayscale voltages are applied to the pixel electrodes 222, the pixel units SP exhibit different brightness, thereby displaying different images in the narrow viewing angle mode, to thereby achieve normal display of the display device in the narrow viewing angle mode.

In the narrow viewing angle mode, due to the use of the dye liquid crystal layer 13, the dye molecules 132 in the dye liquid crystal layer 13 have strong ability to absorb light on the long axis and weak ability to absorb light on the short axis. In the narrow viewing angle mode, the dye molecules 132 can absorb some light, thereby increasing the light receiving effect in the narrow viewing angle mode and accordingly improving the narrow viewing angle display effect. Moreover, a transflective layer 34 is provided between the second polarizer 32 and the first liquid crystal cell 10. Since the backlight transmitted at a large viewing angle is relatively dark in the narrow viewing angle mode, the golden ambient light reflected by the transflective layer 34 can be seen, further enhancing the anti-peeping effect in the narrow viewing angle mode and achieving a golden anti-peeping effect. In the narrow viewing angle mode, the backlight passing through the frontal angle (0°) is relatively strong and can cover the golden ambient light reflected by the transflective layer 34. Therefore, the golden ambient light reflected by the transflective layer 34 at the frontal angle is basically invisible, that is, in the narrow viewing angle mode, the golden ambient light reflected by the transflective layer 34 has little impact on the display at the frontal angle.

As shown in FIG. 15 and FIG. 18, in the identification display mode, the backlight module 50 is in the on state. A common signal Vcom is applied to the viewing angle auxiliary electrode 111, a first narrow viewing angle signal V21 is applied to the first viewing angle control electrode 121a, and a second narrow viewing angle signal V22 is applied to the second viewing angle control electrode 121b, so that there is a relatively large voltage difference (e.g., 1.5-3V) between the viewing angle auxiliary electrode 111 and the first viewing angle control electrode 121a, and between the viewing angle auxiliary electrode 111 and the second viewing angle control electrode 121b. However, the first narrow viewing angle signal V21 and the second narrow viewing angle signal V22 have different amplitudes, that is, the voltage difference between the viewing angle auxiliary electrode 111 and the first viewing angle control electrode 121a is not the same as the voltage difference between the viewing angle auxiliary electrode 111 and the second viewing angle control electrode 121b, thereby forming a relatively strong first vertical electric field (E3 in FIG. 18) between the viewing angle auxiliary electrode 111 and the first viewing angle control electrode 121a, and a relatively strong second vertical electric field (E4 in FIG. 18) between the viewing angle auxiliary electrode 111 and the second viewing angle control electrode 121b. Specifically, the first narrow viewing angle signal V21 and the second narrow viewing angle signal V22 can have the same polarity or opposite polarity. The liquid crystal molecules 131 and the dye molecules 132 corresponding to the identification pattern area 110 are controlled to assume a first tilted posture, and the liquid crystal molecules 131 and the dye molecules 132 corresponding to the non-identification pattern area 120 are controlled to assume a second tilted posture, wherein the tilt angle of the first tilted posture is different from that of the second tilted posture. The dye liquid crystal layer 13 corresponding to the identification pattern area 110 and the dye liquid crystal layer 13 corresponding to the non-identification pattern area 120 have different light receiving effects at a large viewing angle, so that there is a difference in brightness between the identification pattern area 110 and the non-identification pattern area 120 at a large viewing angle. Therefore, the identification pattern (LOGO) corresponding to the identification pattern area 110 can be displayed at a large viewing angle to enhance the brand effect of the product. It can be understood that in the identification display mode, the first liquid crystal cell 10 also presents a narrow viewing angle display effect.

In the identification display mode, a common voltage is applied to the common electrode 221, and a corresponding grayscale voltage is applied to the pixel electrode 222. A voltage difference is formed between the pixel electrode 222 and the common electrode 221, thereby generating a horizontal electric field (E1 in FIG. 18). The positive liquid crystal molecules in the liquid crystal layer 23 are deflected in the horizontal direction, thereby controlling the intensity of light passing through the liquid crystal layer 23 and achieving grayscale display. The grayscale voltage includes 0-255 levels of grayscale voltage. When different grayscale voltages are applied to the pixel electrodes 222, the pixel units SP exhibit different brightness, thereby displaying different images in the identification display mode, to thereby achieve normal display of the display device in the identification display mode.

A person skilled in the art should understand that the remaining structures and working principles of this embodiment are the same as those of the first, second, third and fourth embodiments, and will not be repeated here.

### Sixth Embodiment

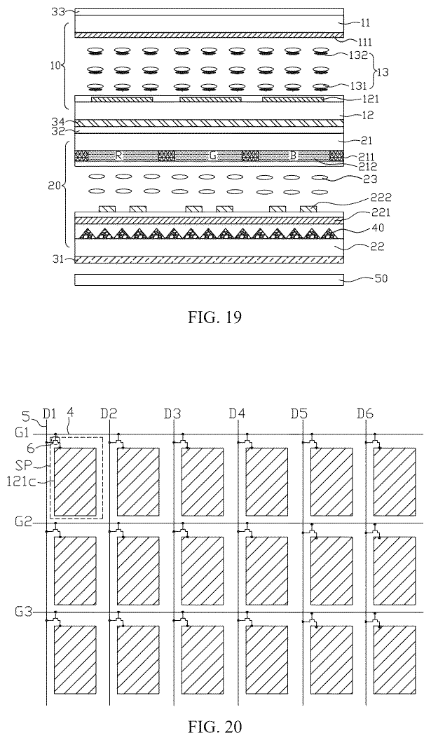

FIG. 19 is a structural schematic diagram of the display device in the initial state according to the sixth embodiment of the present invention. FIG. 20 is a schematic diagram of the planar structure of the second substrate in the sixth embodiment of the present invention. As shown in FIGS. 19 and 20, the display panel, display device, and driving method provided in the sixth embodiment of the present invention are basically the same as those in the fifth embodiment (FIGS. 12 to 18), except that in this embodiment:

Due to the need for reflective display in this embodiment, the transflective layer 34 requires the use of a non-axial transflective film. The transflective layer 34 is a unidirectional perspective film, wherein the unidirectional perspective film has no polarization effect on light, the backlight still remains natural light after passing through the unidirectional perspective film, and the ambient light still remains natural light after being reflected by the unidirectional perspective film. That is, regardless of the polarization direction of the light, the unidirectional perspective film has both transmission and reflection effects on it.

On the second substrate 12, there are multiple second scanning lines 4 and multiple second data lines 5. The second scanning lines 4 correspond to the first scanning lines 1, and the second data lines 5 correspond to the first data lines 2. The viewing angle control electrode 121 includes multiple electrode blocks 121c corresponding to the pixel units SP. The second substrate 12 is provided with a second thin film transistor 6 in each pixel unit SP. The electrode block 121c is electrically connected, through the second thin film transistor 6, to the second scanning line 4 and the second data line 5 adjacent to the second thin film transistor 6. That is, the viewing angle control electrode 121 is divided into multiple mutually insulated electrode blocks 121c, and the electrode blocks 121c correspond one-to-one with the pixel units SP. Then, each electrode block 121c is electrically connected, through the second thin film transistor 6, to the second scanning line 4 and the second data line 5 adjacent to the second thin film transistor 6, thereby achieving individual control of the electrical signal on each electrode block 121c.

The dye liquid crystal layer 13 is aligned parallel to the first substrate 11 and the second substrate 12, and the alignment direction of the dye liquid crystal layer 13 is parallel to the light transmission axis of the third polarizer 33. For example, if the light transmission axis of the third polarizer 33 and the light transmission axis of the second polarizer 32 are both 0°, then the alignment direction of the dye liquid crystal layer 13 is also 0°. That is, in the initial state, the long axis of the dye molecules 132 is parallel to the light transmission axis of the third polarizer 33. Therefore, by controlling the tilt angle of the dye molecules 132 in the dye liquid crystal layer 13, the transmittance of light passing through the dye liquid crystal layer 13 can be controlled. That is, corresponding grayscale voltages can be applied to different electrode blocks 121c to cause the pixel units SP to present different brightness, thus achieving reflective display using ambient light.

The first substrate 11 and the second substrate 12 are both colorless and transparent in the areas corresponding to the pixel units SP, that is, both the first substrate 11 and the second substrate 12 use transparent substrates, and no color resist layer is provided thereon. Therefore, in reflective display, black and white images can be displayed, while in transmissive display using the backlight, color images can be displayed, thereby enabling the display panel to switch between black and white images and color images.

Furthermore, the first liquid crystal cell 10 has an identification pattern area 110 and a non-identification pattern area 120. In the identification display mode, the electrode blocks 121c corresponding to the identification pattern area 110 and the electrode blocks 121c corresponding to the non-identification pattern area 120 are respectively applied with narrow viewing angle signals of different amplitudes. Specifically, the pattern of the identification pattern area 110 can be arbitrarily adjusted according to needs of the users, simply by controlling the electrode blocks 121c in a corresponding area being applied with a corresponding narrow viewing angle signal. Therefore, compared to the fifth embodiment, the identification pattern (LOGO) displayed in this embodiment can be arbitrarily adjusted according to needs of the users, and the display device can further achieve reflective display, that is, using only ambient light to display images.

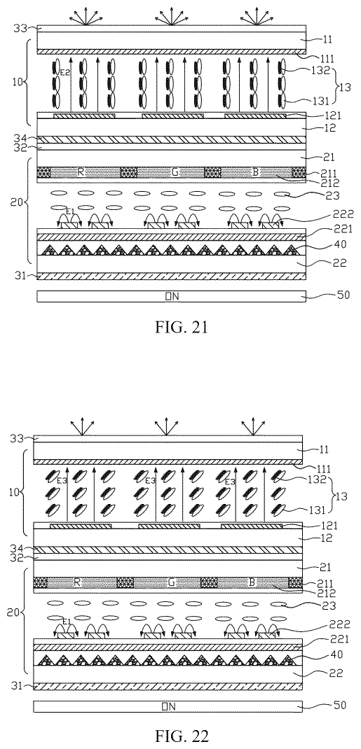

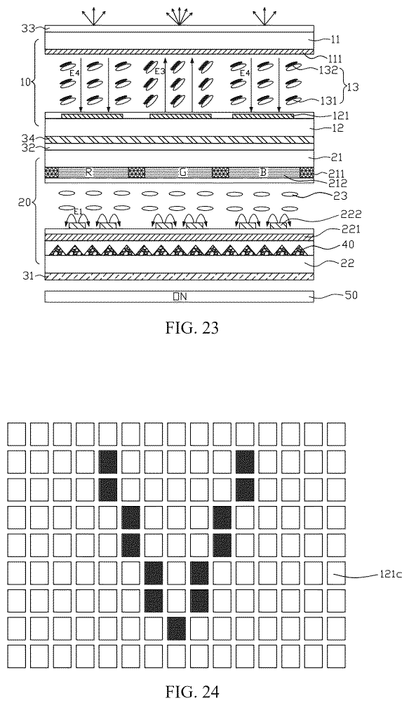

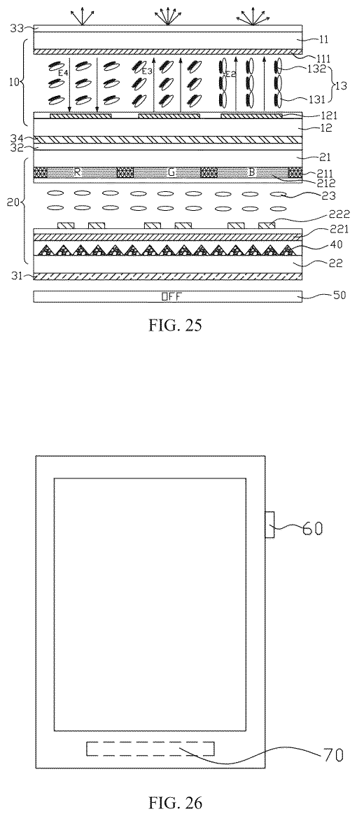

FIG. 21 is a structural schematic diagram of the display device in the wide viewing angle mode according to the sixth embodiment of the present invention. FIG. 22 is a structural schematic diagram of the display device in the narrow viewing angle mode according to the sixth embodiment of the present invention. FIG. 23 is a structural schematic diagram of the display device in the identification display mode according to the sixth embodiment of the present invention. FIG. 24 is a schematic diagram of the planar structure of the display device in the identification display mode according to the sixth embodiment of the present invention. FIG. 25 is a structural schematic diagram of the display device in the reflective display mode according to the sixth embodiment of the present invention. As shown in FIGS. 21 to 25, and referring to FIG. 15, the present invention also provides a driving method for driving the display panel as described above. The driving method includes:

As shown in FIG. 21, and referring to FIG. 15, in the wide viewing angle mode, the backlight module 50 is in the on state. A common signal Vcom is applied to the viewing angle auxiliary electrode 111, and a wide viewing angle signal V1 is applied to the viewing angle control electrode 121, that is, the wide viewing angle signal V1 is applied to all the electrode blocks 121c through the second data lines 5, so that there is a large voltage difference (e.g., 5-10V) between the viewing angle auxiliary electrode 111 and all the electrode blocks 121c, thereby forming a strong vertical electric field (E2 in FIG. 21) between the viewing angle auxiliary electrode 111 and all the electrode blocks 121c, which controls all the liquid crystal molecules 131 and the dye molecules 132 in the dye liquid crystal layer 13 to deflect in a vertical direction and assume a standing posture to thereby achieve a wide viewing angle display effect.

In the wide viewing angle mode, a common voltage is applied to the common electrode 221, and a corresponding grayscale voltage is applied to the pixel electrode 222. A voltage difference is formed between the pixel electrode 222 and the common electrode 221, thereby generating a horizontal electric field (E1 in FIG. 21). The positive liquid crystal molecules in the liquid crystal layer 23 are deflected in the horizontal direction, thereby controlling the intensity of light passing through the liquid crystal layer 23 and achieving grayscale display. The grayscale voltage includes 0-255 levels of grayscale voltage. When different grayscale voltages are applied to the pixel electrodes 222, the pixel units SP exhibit different brightness, thereby displaying different images in the wide viewing angle mode, to thereby achieve normal display of the display device in the wide viewing angle mode.

In the wide viewing angle mode, by setting a prism structure layer 40 with light diffusion effect and combining it with a first polarizer 31 on the side of the second liquid crystal cell 20 away from the first liquid crystal cell 10, the prism structure layer 40 and the first polarizer 31 cooperate with each other to enhance the wide viewing angle display effect while ensuring good wide viewing angle display brightness. In the wide viewing angle mode, due to the standing posture of the liquid crystal molecules 131 and the dye molecules 132 in the dye liquid crystal layer 13, the dye molecules 132 basically do not absorb light. Therefore, the dye molecules 132 will not affect the display effect in the wide viewing angle mode. Moreover, in the wide viewing angle mode, regardless of whether it is from a large viewing angle or a frontal angle (00), the backlight passing through is relatively strong and can cover the golden ambient light reflected by the transflective layer 34 (unidirectional perspective film). Therefore, the golden ambient light reflected by the transflective layer 34 has little impact on the display in the wide viewing angle mode.

As shown in FIG. 22, and referring to FIG. 15, in the narrow viewing angle mode, the backlight module 50 is in the on state. A common signal Vcom is applied to the viewing angle auxiliary electrode 111, and a narrow viewing angle signal V2 is applied to the viewing angle control electrode 121, that is, a first narrow viewing angle signal V21 or a second narrow viewing angle signal V22 is applied to all the electrode blocks 121c through the second data lines 5, so that there is a relatively large voltage difference (e.g., 1.5-3V, preferably 2.7V) between the viewing angle auxiliary electrode 111 and all the electrode blocks 121c, thereby forming a relatively strong vertical electric field (E3 in FIG. 22) between the viewing angle auxiliary electrode 111 and all the electrode blocks 121c, which controls all the liquid crystal molecules 131 and the dye molecules 132 in the dye liquid crystal layer 13 to deflect in a vertical direction and assume the same tilted posture. The dye liquid crystal layer 13 has a light receiving effect at a large viewing angle, that is, the brightness becomes dark at a large viewing angle, to thereby achieve a narrow viewing angle display effect.

In the narrow viewing angle mode, a common voltage is applied to the common electrode 221, and a corresponding grayscale voltage is applied to the pixel electrode 222. A voltage difference is formed between the pixel electrode 222 and the common electrode 221, thereby generating a horizontal electric field (E1 in FIG. 22). The positive liquid crystal molecules in the liquid crystal layer 23 are deflected in the horizontal direction, thereby controlling the intensity of light passing through the liquid crystal layer 23 and achieving grayscale display. The grayscale voltage includes 0-255 levels of grayscale voltage. When different grayscale voltages are applied to the pixel electrodes 222, the pixel units SP exhibit different brightness, thereby displaying different images in the narrow viewing angle mode, to thereby achieve normal display of the display device in the narrow viewing angle mode.

In the narrow viewing angle mode, due to the use of the dye liquid crystal layer 13, the dye molecules 132 in the dye liquid crystal layer 13 have strong ability to absorb light on the long axis and weak ability to absorb light on the short axis. In the narrow viewing angle mode, the dye molecules 132 can absorb some light, thereby increasing the light receiving effect in the narrow viewing angle mode and accordingly improving the narrow viewing angle display effect. Due to the alignment direction of the dye liquid crystal layer 13 being parallel to the light transmission axis of the third polarizer 33 in this embodiment, the dye molecules 132 can absorb more light, further increasing the light receiving effect in the narrow viewing angle mode. Moreover, a transflective layer 34 (unidirectional perspective film) is provided between the second polarizer 32 and the first liquid crystal cell 10. Since the backlight transmitted at a large viewing angle is relatively dark in the narrow viewing angle mode, the golden ambient light reflected by the transflective layer 34 can be seen, further enhancing the anti-peeping effect in the narrow viewing angle mode and achieving a golden anti-peeping effect. In the narrow viewing angle mode, the backlight passing through the frontal angle (0°) is relatively strong and can cover the golden ambient light reflected by the transflective layer 34. Therefore, the golden ambient light reflected by the transflective layer 34 at the frontal angle is basically invisible, that is, in the narrow viewing angle mode, the golden ambient light reflected by the transflective layer 34 has little impact on the display at the frontal angle.

As shown in FIGS. 23 and 24, and referring to FIG. 15, in the identification display mode, the backlight module 50 is in the on state. A common signal Vcom is applied to the viewing angle auxiliary electrode 111, and through the second data lines 5, a first narrow viewing angle signal V21 is applied to the electrode blocks 121c corresponding to the identification pattern area 110, and a second narrow viewing angle signal V22 is applied to the electrode blocks 121c corresponding to the non-identification pattern area 120, so that there is a relatively large voltage difference (e.g., 1.5-3V) between the viewing angle auxiliary electrode 111 and the electrode blocks 121c corresponding to the identification pattern area 110, and between the viewing angle auxiliary electrode 111 and the electrode blocks 121c corresponding to the non-identification pattern area 120. However, the first narrow viewing angle signal V21 and the second narrow viewing angle signal V22 have different amplitudes, that is, the voltage difference between the viewing angle auxiliary electrode 111 and the electrode blocks 121c corresponding to the identification pattern area 110 is not the same as the voltage difference between the viewing angle auxiliary electrode 111 and the electrode blocks 121c corresponding to the non-identification pattern area 120, thereby forming a relatively strong first vertical electric field (E3 in FIG. 23) between the viewing angle auxiliary electrode 111 and the electrode blocks 121c corresponding to the identification pattern area 110, and a relatively strong second vertical electric field (E4 in FIG. 23) between the viewing angle auxiliary electrode 111 and the electrode blocks 121c corresponding to the non-identification pattern area 120. Specifically, the first narrow viewing angle signal V21 and the second narrow viewing angle signal V22 can have the same polarity or opposite polarity. The liquid crystal molecules 131 and the dye molecules 132 corresponding to the identification pattern area 110 are controlled to assume a first tilted posture, and the liquid crystal molecules 131 and the dye molecules 132 corresponding to the non-identification pattern area 120 are controlled to assume a second tilted posture, wherein the tilt angle of the first tilted posture is different from that of the second tilted posture. The dye liquid crystal layer 13 corresponding to the identification pattern area 110 and the dye liquid crystal layer 13 corresponding to the non-identification pattern area 120 have different light receiving effects at a large viewing angle, so that there is a difference in brightness between the identification pattern area 110 and the non-identification pattern area 120 at a large viewing angle. Therefore, the identification pattern (LOGO) corresponding to the identification pattern area 110 can be displayed at a large viewing angle to enhance the brand effect of the product. It can be understood that in the identification display mode, the first liquid crystal cell 10 also presents a narrow viewing angle display effect. In this embodiment, the pattern of the identification pattern area 110 can be arbitrarily adjusted according to needs of the users, that is, by simply controlling the electrode blocks 121c in a corresponding area being applied with a corresponding narrow viewing angle signal, the pattern of the identification pattern area 110 can be adjusted.

In the identification display mode, a common voltage is applied to the common electrode 221, and a corresponding grayscale voltage is applied to the pixel electrode 222. A voltage difference is formed between the pixel electrode 222 and the common electrode 221, thereby generating a horizontal electric field (E1 in FIG. 23). The positive liquid crystal molecules in the liquid crystal layer 23 are deflected in the horizontal direction, thereby controlling the intensity of light passing through the liquid crystal layer 23 and achieving grayscale display. The grayscale voltage includes 0-255 levels of grayscale voltage. When different grayscale voltages are applied to the pixel electrodes 222, the pixel units SP exhibit different brightness, thereby displaying different images in the identification display mode, to thereby achieve normal display of the display device in the identification display mode.

As shown in FIG. 25, in the reflective display mode, the backlight module 50 and the second liquid crystal cell 20 are turned off. A common signal Vcom is applied to the viewing angle auxiliary electrode 111, and corresponding grayscale voltages are applied to the electrode blocks 121c through the second data lines 5, so that different voltage differences are formed between the viewing angle auxiliary electrode 111 and the electrode blocks 121c corresponding to different pixel units SP, and vertical electric fields of different intensities are formed, thereby controlling the intensity of reflected ambient light passing through the first liquid crystal cell 10 to achieve grayscale display. The grayscale voltage includes 0-255 levels of grayscale voltage. When different grayscale voltages are applied to the electrode blocks 121c, the pixel units SP exhibit different brightness to achieve reflective display using ambient light.

A person skilled in the art should understand that the remaining structures and working principles of this embodiment are the same as those of the fifth embodiment, and will not be repeated here.

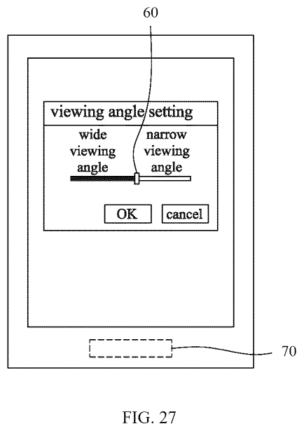

FIGS. 26 and 27 are schematic diagrams of the planar structure of the display device in the present invention. Please refer to FIGS. 26 and 27, the display device is provided with a viewing angle switching button 60 used for the user to send viewing angle switching requests to the display device. The viewing angle switching button 60 can be a physical button (as shown in FIG. 26), or it can be controlled by software or an application (APP) to achieve the switching function (as shown in FIG. 27, for example, the wide and narrow viewing angle modes can be set through a slider). When the user needs to switch between wide and narrow viewing angle modes, the user can send a viewing angle switch request to the display device by operating the viewing angle switch button 60. Finally, different electrical signals are applied to the viewing angle auxiliary electrode 111 and the viewing angle control electrode 121 under control by a driving chip 70, so that the display device can switch between wide and narrow viewing angle modes. When switching to the wide viewing angle, the driving method corresponding to the wide viewing angle mode is adopted, and when switching to narrow viewing angle, the driving method corresponding to the narrow viewing angle mode is adopted. Therefore, the display device in the embodiments of the present invention has strong operational flexibility and convenience, thereby achieving a multifunctional display device that integrates entertainment and privacy confidentiality.

In this description, the directional terms such as “up”, “down”, “left”, “right”, “front” and “back” are defined by the positions of the structures in the drawings and the positions between the structures, and are only for clearly and conveniently expressing technical solutions. It should be understood that the use of the directional terms should not limit the scope of protection claimed in this invention. It should also be understood that the terms “first” and “second”, etc. used herein are only used to distinguish elements, and are not used to limit the number and order.

The above descriptions are only preferred embodiments of the present invention, and do not limit the present invention in any form. Although the present invention has been disclosed above with preferred embodiments, it is not intended to limit the present invention. The persons skilled in the art may make some changes or modifications by using the technical content disclosed above, and if they do not depart from the technical content of the present invention, any simple modifications, equivalent changes and modifications made to the above embodiments still fall within the protection scope of the technical solution of the present invention.

### INDUSTRIAL APPLICABILITY

By providing a prism structure layer with light diffusion effect, and combining it with a reflective polarizer provided on the side of the second liquid crystal cell away from the first liquid crystal cell, the display brightness in the wide viewing angle mode is ensured while improving the wide viewing angle display effect; further, the first liquid crystal cell uses dye molecules, and the dye molecules have a certain light receiving effect in the narrow viewing angle mode to reduce the influence of the prism structure layer on the narrow viewing angle display effect and enhance the narrow viewing angle display effect. By coordinating the prism structure layer, the reflective polarizer and the dye molecules, the wide viewing angle display effect is realized and improved while the narrow viewing angle display effect is not affected or can be improved.

1. A display panel comprising a first liquid crystal cell and a second liquid crystal cell stacked on top of each other, wherein the first liquid crystal cell is located on the light output side of the second liquid crystal cell;
the first liquid crystal cell comprises a first substrate, a second substrate arranged opposite to the first substrate, and a dye liquid crystal layer located between the first substrate and the second substrate, the first substrate is provided with a viewing angle auxiliary electrode, and the second substrate is provided with a viewing angle control electrode that cooperates with the viewing angle auxiliary electrode;
the second liquid crystal cell comprises a color film substrate, an array substrate arranged opposite to the color film substrate, and a liquid crystal layer arranged between the color film substrate and the array substrate;
a first polarizer is provided on the side of the second liquid crystal cell away from the first liquid crystal cell, and a second polarizer is provided on the side of the second liquid crystal cell near the first liquid crystal cell, the light transmission axis of the second polarizer is perpendicular to the light transmission axis of the first polarizer, the first polarizer is a reflective polarizer, a prism structure layer is provided in the first liquid crystal cell and/or the second liquid crystal cell, and the prism structure layer has a light diffusion effect on backlight.

2. The display panel according to claim 1, wherein the second polarizer is a reflective polarizer; and/or a transflective layer is provided between the second polarizer and the first liquid crystal cell.

3. The display panel according to claim 2, wherein the first liquid crystal cell has an identification pattern area and a non-identification pattern area, the viewing angle control electrode comprises a first viewing angle control electrode corresponding to the identification pattern area and a second viewing angle control electrode corresponding to the non-identification pattern area, the first viewing angle control electrode and the second viewing angle control electrode are insulated and spaced apart from each other;
in the identification display mode, the first viewing angle control electrode and the second viewing angle control electrode are respectively applied with narrow viewing angle signals of different amplitudes.

4. The display panel according to claim 3, wherein the first viewing angle control electrode and the second viewing angle control electrode are located on the same layer, or the first viewing angle control electrode and the second viewing angle control electrode are located on different layers.

5. The display panel according to claim 2, wherein the array substrate is provided with multiple first scanning lines and multiple first data lines, the multiple first scanning lines and the multiple first data lines are insulated from each other and intersected to form multiple pixel units, the array substrate is provided with a pixel electrode and a first thin film transistor in each pixel unit, and the pixel electrode is electrically connected, through the first thin film transistor, to the first scanning line and the first data line adjacent to the first thin film transistor;
the second substrate is provided with multiple second scanning lines and multiple second data lines, the second scanning lines correspond to the first scanning lines, the second data lines correspond to the first data lines, the viewing angle control electrode comprises multiple electrode blocks corresponding to the pixel units, the second substrate is provided with a second thin film transistor in each pixel unit, and the electrode block is electrically connected, through the second thin film transistor, to the second scanning line and the second data line adjacent to the second thin film transistor;
the first liquid crystal cell has an identification pattern area and a non-identification pattern area, and in the identification display mode, the electrode blocks corresponding to the identification pattern area and the electrode blocks corresponding to the non-identification pattern area are respectively applied with narrow viewing angle signals of different amplitudes.

6. The display panel according to claim 1, wherein a third polarizer is provided on the side of the first liquid crystal cell away from the second liquid crystal cell, and the light transmission axis of the third polarizer is parallel to the light transmission axis of the second polarizer.

7. The display panel according to claim 6, wherein a transflective layer is provided between the second polarizer and the first liquid crystal cell, the transflective layer is a unidirectional perspective film, the dye liquid crystal layer is aligned parallel to the first substrate and the second substrate, and the alignment direction of the dye liquid crystal layer is parallel to the light transmission axis of the third polarizer;
the array substrate is provided with multiple first scanning lines and multiple first data lines, the multiple first scanning lines and the multiple first data lines are insulated from each other and intersected to form multiple pixel units, the array substrate is provided with a pixel electrode and a first thin film transistor in each pixel unit, and the pixel electrode is electrically connected, through the first thin film transistor, to the first scanning line and the first data line adjacent to the first thin film transistor;
the second substrate is provided with multiple second scanning lines and multiple second data lines, the second scanning lines correspond to the first scanning lines, the second data lines correspond to the first data lines, the viewing angle control electrode comprises multiple electrode blocks corresponding to the pixel units, the second substrate is provided with a second thin film transistor in each pixel unit, and the electrode block is electrically connected, through the second thin film transistor, to the second scanning line and the second data line adjacent to the second thin film transistor;
in the reflective display mode, corresponding grayscale voltages are applied to the electrode blocks.

8. The display panel according to claim 7, wherein the first substrate and the second substrate are both colorless and transparent in the areas corresponding to the pixel units.

9. The display panel according to claim 1, wherein the first substrate and/or the second substrate are provided with a protrusion on the side facing the dye liquid crystal layer, and the protrusion corresponds to the display area of the display panel.

10. The display panel according to claim 1, wherein the prism structure layer is provided on the side of the second substrate facing the dye liquid crystal layer, and/or the prism structure layer is provided on the side of the array substrate facing the liquid crystal layer.

11. A display device comprising a backlight module and the display panel according to claim 1, wherein the display panel is provided on the light output side of the backlight module.

12. A driving method used to drive the display panel according to claim 1, the driving method comprising:
in the wide viewing angle mode, a common signal is applied to the viewing angle auxiliary electrode, and a wide viewing angle signal is applied to the viewing angle control electrode to control liquid crystal molecules and dye molecules in the dye liquid crystal layer to assume a standing posture;
in the narrow viewing angle mode, a common signal is applied to the viewing angle auxiliary electrode, and a narrow viewing angle signal is applied to the viewing angle control electrode to control the liquid crystal molecules and the dye molecules in the dye liquid crystal layer to assume a tilted posture.

13. The driving method according to claim 12, wherein the second polarizer is a reflective polarizer, and/or a transflective layer is provided between the second polarizer and the first liquid crystal cell;
the first liquid crystal cell has an identification pattern area and a non-identification pattern area, the viewing angle control electrode comprises a first viewing angle control electrode corresponding to the identification pattern area and a second viewing angle control electrode corresponding to the non-identification pattern area, the first viewing angle control electrode and the second viewing angle control electrode are insulated and spaced apart from each other;
in the identification display mode, a common signal is applied to the viewing angle auxiliary electrode, a first narrow viewing angle signal is applied to the first viewing angle control electrode, and a second narrow viewing angle signal is applied to the second viewing angle control electrode, the first narrow viewing angle signal and the second narrow viewing angle signal have different amplitudes, wherein the liquid crystal molecules and the dye molecules corresponding to the identification pattern area are controlled to assume a first tilted posture, and the liquid crystal molecules and the dye molecules corresponding to the non-identification pattern area are controlled to assume a second tilted posture.

14. The driving method according to claim 12, wherein the second polarizer is a reflective polarizer, and/or a transflective layer is provided between the second polarizer and the first liquid crystal cell;
the first liquid crystal cell has an identification pattern area and a non-identification pattern area, and the viewing angle control electrode comprises multiple electrode blocks corresponding to the pixel units;
in the identification display mode, a common signal is applied to the viewing angle auxiliary electrode, a first narrow viewing angle signal is applied to the electrode blocks corresponding to the identification pattern area, and a second narrow viewing angle signal is applied to the electrode blocks corresponding to the non-identification pattern area, the first narrow viewing angle signal and the second narrow viewing angle signal have different amplitudes, wherein the liquid crystal molecules and the dye molecules corresponding to the identification pattern area are controlled to assume a first tilted posture, and the liquid crystal molecules and the dye molecules corresponding to the non-identification pattern area are controlled to assume a second tilted posture.

15. The driving method according to claim 12, wherein a transflective layer is provided between the second polarizer and the first liquid crystal cell, and the transflective layer is a unidirectional perspective film;
the first liquid crystal cell is provided with a third polarizer on the side away from the second liquid crystal cell, the light transmission axis of the third polarizer is parallel to the light transmission axis of the second polarizer, the dye liquid crystal layer is aligned parallel to the first substrate and the second substrate, and the alignment direction of the dye liquid crystal layer is parallel to the light transmission axis of the third polarizer, the viewing angle control electrode comprises multiple electrode blocks corresponding to the pixel units;
in the reflective display mode, the backlight module and the second liquid crystal cell are turned off, a common signal is applied to the viewing angle auxiliary electrode, and corresponding grayscale voltages are applied to the electrode blocks.
